(19) United States
(12) Patent Application Publication
(10) Pub. No.: US 2023/0087056 A1
(43) Pub. Date: Mar. 23, 2023

(54) DISPLAY PANEL AND DISPLAY DEVICE

(71) Applicant: WUHAN CHINA STAR OPTOELECTRONICS TECHNOLOGY CO., LTD, Wuhan (CN)

(72) Inventor: Xueyun LI, Wuhan (CN)

(73) Assignee: WUHAN CHINA STAR OPTOELECTRONICS TECHNOLOGY CO., LTD, Wuhan (CN)

(21) Appl. No.: 16/970,360

(22) PCT Filed: Dec. 25, 2019
(86) PCT No.: PCT/CN2019/128366

§ 371 Date: Aug. 16, 2020

(30) Foreign Application Priority Data
Dec. 11, 2019 (CN) 201911268980.2

(51) Int. Cl. G02F 1/1362

(52) U.S. Cl. CPC G02F 1/136222; G02F 1/136204

(57) ABSTRACT

A display panel and a display device are provided. A conductive adhesive is disposed on at least one corner of a color filter substrate, or on an edge of the display panel away from a bonding pad area, so that a bezel of the display panel can be reduced, and its antistatic ability is maintained.

### FIELD OF DISCLOSURE

The present application relates to the field of display technologies, and in particular, to a display panel and a display device.

### BACKGROUND

Liquid crystal displays have been widely used in people's lives, such as display screens of mobile phones, computers, televisions, etc. With a development of a display technology and people's requirements for an improvement of the display technology, narrow-bezel liquid crystal displays and full-screen liquid crystal displays have been applied to terminals such as mobile phones and notebooks. The narrow bezel liquid crystal displays and the full-screen liquid crystal displays usually use a chip on film (COF) structure, that is, a display chip is bound to a COF, and then the COF is bound to a bonding pad area of an array substrate. In this way, a liquid crystal display with the COF structure can achieve an extremely narrow lower bezel.

At present, in an in-cell touch liquid crystal display, a high-resistance film needs to be used in a manufacturing process of a surface of a color filter glass. This is because the high-resistance film can prevent static electricity. Specifically, the high resistance film is connected to an array substrate through a conductive material such as silver glue to avoid static electricity. However, if a height (i.e., a thickness) of the silver glue is too large, it will not be conducive to reducing a width of a lower bezel, and if the height of the silver glue is too small, it will cause poor contact between the silver glue and the high resistance film.

Therefore, how to effectively solve the problem of realizing a narrow bezel panel without affecting its antistatic ability is an important issue in the display technology.

### SUMMARY OF DISCLOSURE

The present disclosure provides a display panel and a display device, which can solve several existing problems.

According to a first aspect of the present disclosure, the present disclosure provides a display panel, including a display area, a non-display area, an array substrate, a color filter substrate, an anti-static layer, and a conductive adhesive. The non-display area surrounds the display area. The color filter substrate is disposed on the array substrate, and each corner of the color filter substrate includes a special-shaped region. The anti-static layer is disposed on the color filter substrate, and the anti-static layer includes a high resistance film or an indium tin oxide. The conductive adhesive is disposed on at least one corner or one edge of the color filter substrate. The conductive adhesive is electrically connected to the array substrate and the anti-static layer, and material of the conductive adhesive includes silver.

Furthermore, the display panel further includes a lower polarizer, a liquid crystal layer, and an upper polarizer. The lower polarizer is disposed below the array substrate. The liquid crystal layer is disposed between the array substrate and the color filter substrate. The upper polarizer is disposed on the anti-static layer.

Furthermore, an area of the upper polarizer is less than an area of the color filter substrate.

Furthermore, the conductive adhesive is disposed at a corner of the color filter substrate.

Furthermore, the conductive adhesive is disposed at two corners of the color filter substrate.

Furthermore, the conductive adhesive is disposed at four corners of the color filter substrate.

Furthermore, the array substrate includes a bonding pad area disposed in the non-display area of the display panel, and the bonding pad area is far from the one edge.

According to a second aspect of the present disclosure, the present disclosure provides a display panel, including a display area, a non-display area, an array substrate, a color filter substrate, an anti-static layer, and a conductive adhesive. The non-display area surrounds the display area. The color filter substrate is disposed on the array substrate, and each corner of the color filter substrate includes a special-shaped region. The anti-static layer is disposed on the color filter substrate. The conductive adhesive is disposed on at least one corner or one edge of the color filter substrate. The conductive adhesive is electrically connected to the array substrate and the anti-static layer.

Furthermore, the display panel further includes a lower polarizer, a liquid crystal layer, and an upper polarizer. The lower polarizer is disposed below the array substrate. The liquid crystal layer is disposed between the array substrate and the color filter substrate. The upper polarizer is disposed on the anti-static layer.

Furthermore, an area of the upper polarizer is less than an area of the color filter substrate.

Furthermore, material of the conductive adhesive includes silver.

Furthermore, the conductive adhesive is disposed at a corner of the color filter substrate.

Furthermore, the conductive adhesive is disposed at two corners of the color filter substrate.

Furthermore, the conductive adhesive is disposed at four corners of the color filter substrate.

Furthermore, the anti-static layer includes a high resistance film or an indium tin oxide.

Furthermore, the array substrate includes a bonding pad area disposed in the non-display area of the display panel, and the bonding pad area is far from the one edge.

According to a third aspect of the present disclosure, the present disclosure provides a display device including a display panel as described above.

In comparison with the prior art, embodiments of the present disclosure by disposing the conductive adhesive on the at least one corner of the color filter substrate, or on the edge of the display panel away from the bonding pad area, so that a bezel of the display panel can be reduced, and its antistatic ability is maintained.

### BRIEF DESCRIPTION OF DRAWINGS

FIG. 1 is a schematic diagram of a first display panel according to an embodiment of the present disclosure.

FIG. 2 is a cross-sectional view of the first display panel of the embodiment of the present disclosure along a line A-B.

FIG. 3 is a schematic diagram of a second display panel according to an embodiment of the present disclosure.

FIG. 4 is a cross-sectional view of the second display panel of the embodiment of the present disclosure along a line A-B.

FIG. 5 is a schematic diagram of a third display panel according to an embodiment of the present disclosure.

FIG. 6 is a cross-sectional view of the third display panel of the embodiment of the present disclosure along a line A-B.

FIG. 7 is a schematic diagram of a fourth display panel according to an embodiment of the present disclosure.

FIG. 8 is a cross-sectional view of the fourth display panel of the embodiment of the present disclosure along a line A-B.

FIG. 9 is a schematic diagram of a display device according to an embodiment of the present disclosure.

### DETAILED DESCRIPTION

The technical solution in the embodiments of the present disclosure is clearly and completely described below in combination with the accompanying drawings. Obviously, the embodiments described below are just a part but not all of the embodiments of the present disclosure. Based on the embodiments in the present disclosure, all the other embodiments obtained by the ordinary skill in the art without contributing creative effort shall fall within the scope of protection of the present disclosure.

Terms such as “first”, “second”, and “third”, etc. (if exists) in the specification, claims, and the aforementioned accompanying drawings are configured to differentiate similar objects, and may not necessarily configured to illustrate specific order or sequence. It should be understood that data used in such way may be exchanged under proper situations, thus allowing the disclosed embodiments described herein to be implemented in other orders than that illustrated or described here. Further, terms of “comprising” and “including” and any their derivatives are intended to cover non-excluding inclusions.

In specific implementations, the drawings discussed below and the embodiments configured to describe principles of the present disclosure are for illustration only and should not be construed as limiting the scope of the present disclosure. Those skilled in the art will understand that the principles of the present disclosure may be implemented in any suitably arranged system. Exemplary embodiments will be explained in detail, and examples of the embodiments are shown in the drawings. In addition, a terminal according to exemplary embodiments will be described in detail with reference to the accompanying drawings. The same reference numerals in the drawings refer to the same elements.

The terminology used in this detailed description is only configured to describe a specific embodiment, and is not intended to show the concept of the present disclosure. Unless the context clearly indicates a different meaning, expressions used in the singular encompass the expression in the plural. In the present disclosure, it should be understood that terms such as “including”, “having”, and “containing” are intended to indicate the possibility of the features, numbers, steps, actions, or combinations thereof disclosed in the present disclosure, and that are not intended to exclude the possibility that one or more other features, numbers, steps, actions, or combinations thereof may exist or may be added. The same reference numerals in the drawings refer to the same parts.

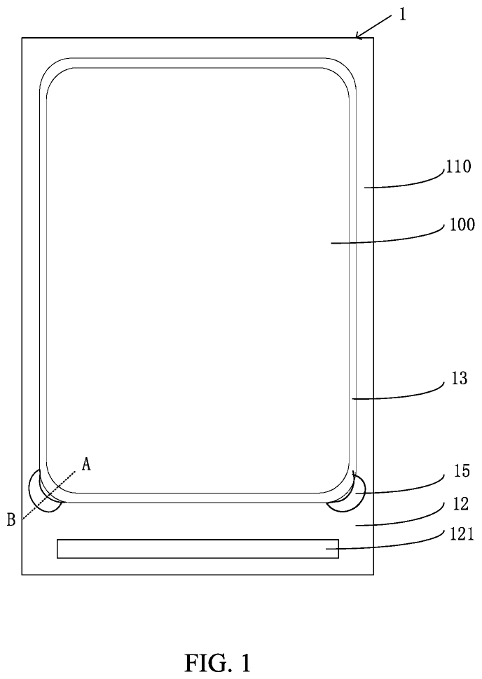

As shown in FIG. 1, an embodiment of the present disclosure provides a display panel 1 including a display area 100, a non-display area 110, an array substrate 12, a bonding pad area 121, a color filter substrate 13, and a conductive adhesive 15.

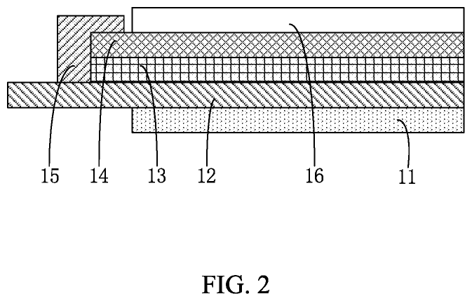

As shown in FIG. 2, the embodiment of the present disclosure provides the display panel including a lower polarizer 11, the array substrate 12, the color filter substrate 13, an anti-static layer 14, the conductive adhesive 15, and an upper polarizer 16.

Referring to FIG. 1 and FIG. 2, the non-display area 110 is located at a periphery of the display area 100, and the conductive adhesive 15 is disposed at two corners of the color filter substrate 13, and the two corners are special-shaped regions.

The array substrate 12 is disposed on the lower polarizer 11, and the array substrate 12 is provided with a bonding pad area 121. The bonding pad area 121 is used for bonding a COF, which is beneficial to realize a narrow bezel. The bonding pad area 121 is disposed at one end of the non-display area 110 of the display panel 1.

The color filter substrate 13 is disposed on the array substrate 12. A vertical projection of the color filter substrate 13 on the array substrate 12 falls within a region of edges of the array substrate 12, that is, a projection area of the color filter substrate 13 on the array substrate 12 is less than an area of the array substrate 12. The color filter substrate 13 is configured to display colors of the display panel 1.

The anti-static layer 14 is disposed on the color filter substrate 13. Vertical projections of the color filter substrate 13 and the anti-static layer 14 on the array substrate 12 are overlapped, that is, a projection area of the anti-static layer 14 on the array substrate 12 is less than the area of the array substrate 12. Moreover, the projection areas of the anti-static layer 14 and the color filter substrate 13 on the array substrate 12 are the same. The anti-static layer 14 includes, but is not limited to, a high resistance film or an indium tin oxide, and is configured to prevent static electricity.

In this embodiment, the conductive adhesive 15 is disposed at two corners of the color filter substrate 13 near the bonding pad area 121, and the conductive adhesive 15 is electrically connected to the array substrate 12 and the anti-static layer 14, respectively, so as to conduct ground terminals on the anti-static layer 14 and the array substrate 12, and to achieve an anti-static performance.

In other embodiments, the conductive adhesive 15 may be disposed at any two corners of the color filter substrate 13.

The upper polarizer 16 is disposed on the anti-static layer 14. The vertical projection of the anti-static layer 14 on the array substrate 12 falls outside a vertical projection of the upper polarizer 16 on the array substrate 12. That is, a projection area of the upper polarizer 16 on the array substrate 12 is less than an area of color filter substrate 13, and vertical projections of upper polarizer 16 and lower polarizer 11 on array substrate 12 are overlapped. That is, projection areas of the upper polarizer 16 and the lower polarizer 11 on the array substrate 12 are the same. In other embodiments, the projection areas of the upper polarizer 16 and the lower polarizer 11 may be different. For example, the projection area of upper polarizer 16 is less than the projection area of lower polarizer 11.

The present disclosure sets the conductive adhesive at at least one corner of the color filter substrate, rather than a position near the bonding pad area as in the prior art. In this way, a space of four corners (circular chamfered positions) of the edge of the color filter substrate can be fully configured to set the conductive adhesive, so that the bezel of the display panel can be reduced, and its antistatic ability is not affected.

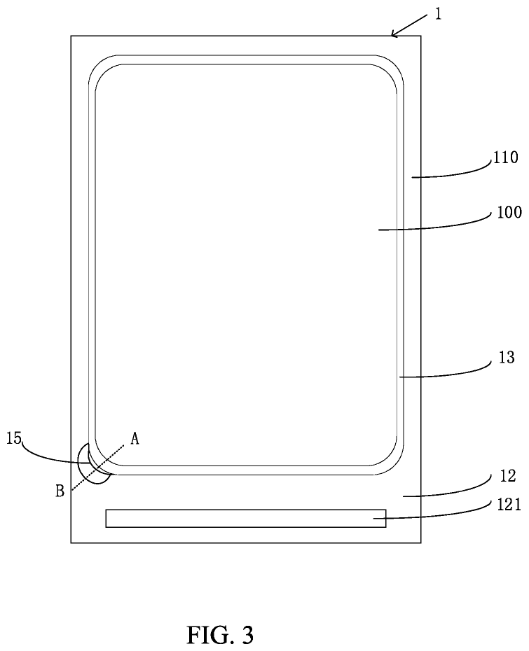

As shown in FIG. 3, an embodiment of the present disclosure provides a display panel 1 including a display area 100, a non-display area 110, an array substrate 12, a bonding pad area 121, a color filter substrate 13, and a conductive adhesive 15.

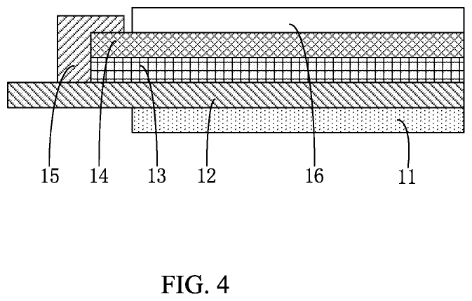

As shown in FIG. 4, the embodiment of the present disclosure provides the display panel including a lower polarizer 11, the array substrate 12, the color filter substrate 13, an anti-static layer 14, the conductive adhesive 15, and an upper polarizer 16.

Referring to FIG. 3 and FIG. 4, the non-display area 110 is located at a periphery of the display area 100, and the conductive adhesive 15 is disposed at a corner of the color filter substrate 13, and the corner is a special-shaped region.

The array substrate 12 is disposed on the lower polarizer 11, and the array substrate 12 is provided with a bonding pad area 121. The bonding pad area 121 is used for bonding a COF, which is beneficial to realize a narrow bezel. The bonding pad area 121 is disposed at one end of the non-display area 110 of the display panel 1.

The color filter substrate 13 is disposed on the array substrate 12. A vertical projection of the color filter substrate 13 on the array substrate 12 falls within a region of edges of the array substrate 12, that is, a projection area of the color filter substrate 13 on the array substrate 12 is less than an area of the array substrate 12. The color filter substrate 13 is configured to display colors of the display panel 1.

The anti-static layer 14 is disposed on the color filter substrate 13. Vertical projections of the color filter substrate 13 and the anti-static layer 14 on the array substrate 12 are overlapped, that is, a projection area of the anti-static layer 14 on the array substrate 12 is less than the area of the array substrate 12. Moreover, the projection areas of the anti-static layer 14 and the color filter substrate 13 on the array substrate 12 are the same. The anti-static layer 14 includes, but is not limited to, a high resistance film or an indium tin oxide, and is configured to prevent static electricity.

In this embodiment, the conductive adhesive 15 is disposed at a corner of the color filter substrate 13 near the bonding pad area 121, and the conductive adhesive 15 is electrically connected to the array substrate 12 and the anti-static layer 14, respectively, so as to conduct ground terminals on the anti-static layer 14 and the array substrate 12, and to achieve an anti-static performance.

In other embodiments, the conductive adhesive 15 may be disposed at any one corner of the color filter substrate 13.

The upper polarizer 16 is disposed on the anti-static layer 14. The vertical projection of the anti-static layer 14 on the array substrate 12 falls outside a vertical projection of the upper polarizer 16 on the array substrate 12. That is, a projection area of the upper polarizer 16 on the array substrate 12 is less than an area of color filter substrate 13, and vertical projections of upper polarizer 16 and lower polarizer 11 on array substrate 12 are overlapped. That is, projection areas of the upper polarizer 16 and the lower polarizer 11 on the array substrate 12 are the same. In other embodiments, the projection areas of the upper polarizer 16 and the lower polarizer 11 may be different. For example, the projection area of upper polarizer 16 is less than the projection area of lower polarizer 11.

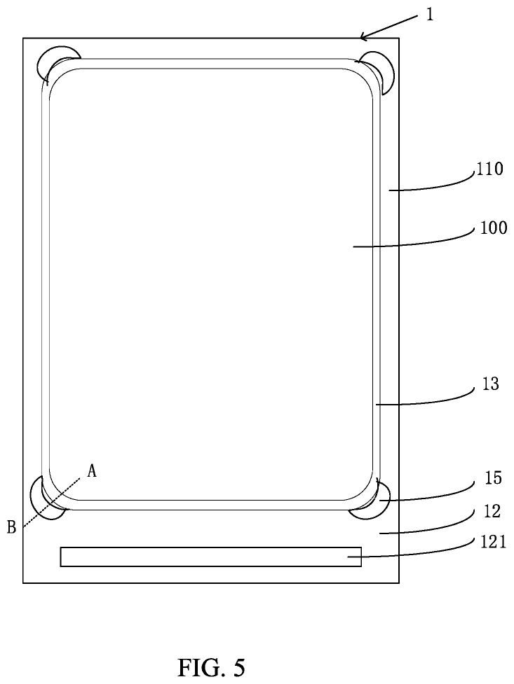

As shown in FIG. 5, an embodiment of the present disclosure provides a display panel 1 including a display area 100, a non-display area 110, an array substrate 12, a bonding pad area 121, a color filter substrate 13, and a conductive adhesive 15.

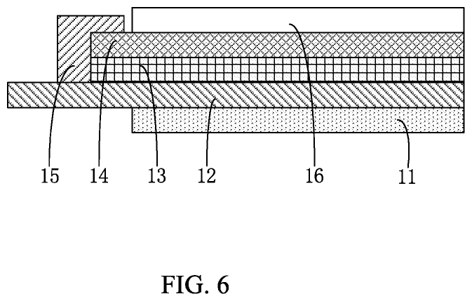

As shown in FIG. 6, the embodiment of the present disclosure provides the display panel including a lower polarizer 11, the array substrate 12, the color filter substrate 13, an anti-static layer 14, the conductive adhesive 15, and an upper polarizer 16.

Referring to FIG. 5 and FIG. 6, the non-display area 110 is located at a periphery of the display area 100, and the conductive adhesive 15 is disposed at four corners of the color filter substrate 13, and the corners are special-shaped regions.

The array substrate 12 is disposed on the lower polarizer 11, and the array substrate 12 is provided with a bonding pad area 121. The bonding pad area 121 is used for bonding a COF, which is beneficial to realize a narrow bezel. The bonding pad area 121 is disposed at one end of the non-display area 110 of the display panel 1.

The color filter substrate 13 is disposed on the array substrate 12. A vertical projection of the color filter substrate 13 on the array substrate 12 falls within a region of edges of the array substrate 12, that is, a projection area of the color filter substrate 13 on the array substrate 12 is less than an area of the array substrate 12. The color filter substrate 13 is configured to display colors of the display panel 1.

The anti-static layer 14 is disposed on the color filter substrate 13. Vertical projections of the color filter substrate 13 and the anti-static layer 14 on the array substrate 12 are overlapped, that is, a projection area of the anti-static layer 14 on the array substrate 12 is less than the area of the array substrate 12. Moreover, the projection areas of the anti-static layer 14 and the color filter substrate 13 on the array substrate 12 are the same. The anti-static layer 14 includes, but is not limited to, a high resistance film or an indium tin oxide, and is configured to prevent static electricity.

In this embodiment, the conductive adhesive 15 is disposed at four corners of the color filter substrate 13 near the bonding pad area 121, and the conductive adhesive 15 is electrically connected to the array substrate 12 and the anti-static layer 14, respectively, so as to conduct ground terminals on the anti-static layer 14 and the array substrate 12, and to achieve an anti-static performance.

The upper polarizer 16 is disposed on the anti-static layer 14. The vertical projection of the anti-static layer 14 on the array substrate 12 falls outside a vertical projection of the upper polarizer 16 on the array substrate 12. That is, a projection area of the upper polarizer 16 on the array substrate 12 is less than an area of color filter substrate 13, and vertical projections of upper polarizer 16 and lower polarizer 11 on array substrate 12 are overlapped. That is, projection areas of the upper polarizer 16 and the lower polarizer 11 on the array substrate 12 are the same. In other embodiments, the projection areas of the upper polarizer 16 and the lower polarizer 11 may be different. For example, the projection area of upper polarizer 16 is less than the projection area of lower polarizer 11.

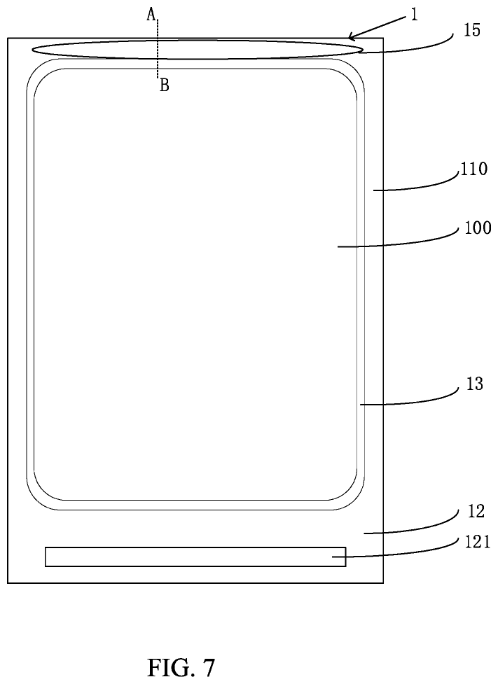

As shown in FIG. 7, an embodiment of the present disclosure provides a display panel 1 including a display area 100, a non-display area 110, an array substrate 12, a bonding pad area 121, a color filter substrate 13, and a conductive adhesive 15.

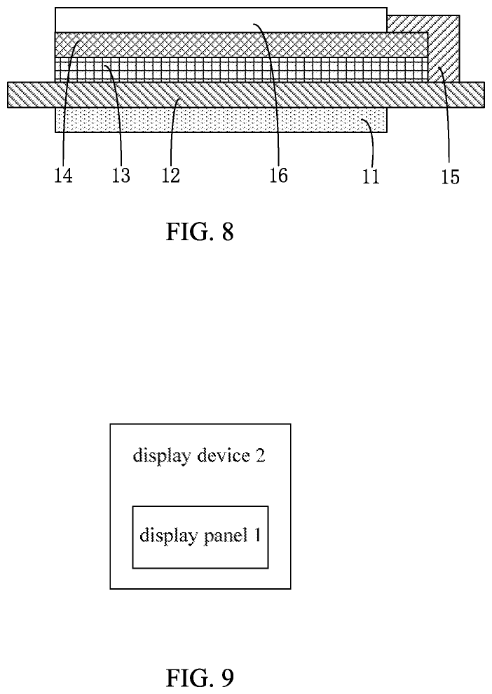

As shown in FIG. 8, the embodiment of the present disclosure provides the display panel including a lower polarizer 11, the array substrate 12, the color filter substrate 13, an anti-static layer 14, the conductive adhesive 15, and an upper polarizer 16.

Referring to FIG. 7 and FIG. 8, the non-display area 110 is located at a periphery of the display area 100.

The array substrate 12 is disposed on the lower polarizer 11, and the array substrate 12 is provided with a bonding pad area 121. The bonding pad area 121 is used for bonding a COF, which is beneficial to realize a narrow bezel. The bonding pad area 121 is disposed at one end of the non-display area 110 of the display panel 1.

The color filter substrate 13 is disposed on the array substrate 12. A vertical projection of the color filter substrate 13 on the array substrate 12 falls within a region of edges of the array substrate 12, that is, a projection area of the color filter substrate 13 on the array substrate 12 is less than an area of the array substrate 12. The color filter substrate 13 is configured to display colors of the display panel 1.

The anti-static layer 14 is disposed on the color filter substrate 13. Vertical projections of the color filter substrate 13 and the anti-static layer 14 on the array substrate 12 are overlapped, that is, a projection area of the anti-static layer 14 on the array substrate 12 is less than the area of the array substrate 12. Moreover, the projection areas of the anti-static layer 14 and the color filter substrate 13 on the array substrate 12 are the same. The anti-static layer 14 includes, but is not limited to, a high resistance film or an indium tin oxide, and is configured to prevent static electricity.

The conductive adhesive 15 is disposed on one edge of the color filter substrate 13 away from the bonding pad area 121. The conductive adhesive 15 is electrically connected to the array substrate 12 and the anti-static layer 14, respectively, so as to conduct ground terminals on the anti-static layer 14 and the array substrate 12, and to achieve an anti-static performance.

In other embodiments, the conductive adhesive 15 may also be disposed on two edges of the color filter substrate 13.

The upper polarizer 16 is disposed on the anti-static layer 14. The vertical projection of the anti-static layer 14 on the array substrate 12 falls outside a vertical projection of the upper polarizer 16 on the array substrate 12. That is, a projection area of the upper polarizer 16 on the array substrate 12 is less than an area of color filter substrate 13, and vertical projections of upper polarizer 16 and lower polarizer 11 on array substrate 12 are overlapped. That is, projection areas of the upper polarizer 16 and the lower polarizer 11 on the array substrate 12 are the same. In other embodiments, the projection areas of the upper polarizer 16 and the lower polarizer 11 may be different. For example, the projection area of upper polarizer 16 is less than the projection area of lower polarizer 11.

As shown in FIG. 9, an embodiment of the present disclosure further provides a display device 2 including the display panel 1 described above. The display device 2 may be any product or component having a display function such as a mobile phone, a tablet, a television, a display, a notebook, a digital photo frame, a navigator, and the like.

The present disclosure by disposing the conductive adhesive on the at least one corner of the color filter substrate, or on the edge of the display panel away from the bonding pad area, so a bezel of the display panel can be reduced, and its antistatic ability is maintained.

The display panel and display device provided in the present disclosure are described above in details. The principles and embodiments of the present disclosure are described by means of specific embodiments, and the description of the above embodiments is only configured to help in understanding the method and the idea of the present disclosure. For those of ordinary skill in the art, under the concept of the present disclosure, there could be some changes in detailed embodiments and applications. In conclusion, the contents of the specification should not be interpreted as limiting the present disclosure.

What is claimed is:

1. A display panel, comprising:
a display area;
a non-display area surrounding the display area;
an array substrate;
a color filter substrate disposed on the array substrate, wherein each corner of the color filter substrate comprises a special-shaped region;
an anti-static layer disposed on the color filter substrate, wherein the anti-static layer comprises a high resistance film or an indium tin oxide; and
a conductive adhesive disposed on at least one corner or one edge of the color filter substrate, wherein the conductive adhesive is electrically connected to the array substrate and the anti-static layer, and material of the conductive adhesive comprises silver.

2. The display panel as claimed in claim 1, further comprising:
a lower polarizer disposed below the array substrate;
a liquid crystal layer disposed between the array substrate and the color filter substrate; and
an upper polarizer disposed on the anti-static layer.

3. The display panel as claimed in claim 2, wherein an area of the upper polarizer is less than an area of the color filter substrate.

4. The display panel as claimed in claim 1, wherein the conductive adhesive is disposed at a corner of the color filter substrate.

5. The display panel as claimed in claim 1, wherein the conductive adhesive is disposed at two corners of the color filter substrate.

6. The display panel as claimed in claim 1, wherein the conductive adhesive is disposed at four corners of the color filter substrate.

7. The display panel as claimed in claim 1, wherein the array substrate comprises a bonding pad area disposed in the non-display area of the display panel, and the bonding pad area is far from the one edge.

8. A display panel, comprising:
a display area;
a non-display area surrounding the display area;
an array substrate;
a color filter substrate disposed on the array substrate, wherein each corner of the color filter substrate comprises a special-shaped region;
an anti-static layer disposed on the color filter substrate; and
a conductive adhesive disposed on at least one corner or one edge of the color filter substrate, wherein the conductive adhesive is electrically connected to the array substrate and the anti-static layer.

9. The display panel as claimed in claim 8, further comprising:
a lower polarizer disposed below the array substrate;
a liquid crystal layer disposed between the array substrate and the color filter substrate; and
an upper polarizer disposed on the anti-static layer.

10. The display panel as claimed in claim 9, wherein an area of the upper polarizer is less than an area of the color filter substrate.

11. The display panel as claimed in claim 8, wherein material of the conductive adhesive comprises silver.

12. The display panel as claimed in claim 8, wherein the conductive adhesive is disposed at a corner of the color filter substrate.

13. The display panel as claimed in claim 8, wherein the conductive adhesive is disposed at two corners of the color filter substrate.

14. The display panel as claimed in claim 8, wherein the conductive adhesive is disposed at four corners of the color filter substrate.

15. The display panel as claimed in claim 8, wherein the anti-static layer comprises a high resistance film or an indium tin oxide.

16. The display panel as claimed in claim 8, wherein the array substrate comprises a bonding pad area disposed in the non-display area of the display panel, and the bonding pad area is far from the one edge.

17. A display device, comprising a display panel as claimed in claim 8.
